(19) United States
(12) Patent Application Publication
(10) Pub. No.: US 2007/0126572 A1
(43) Pub. Date: Jun. 7, 2007

(54) LOCATION-BASED EMERGENCY MESSAGE SYSTEM FOR MOBILE COMMUNICATION DEVICES

(76) Inventor: Brent Richard Wadman, LaVista, NE (US)

Correspondence Address: Brent Wadman, 17007 Karen Street, Omaha, NE, 68135, US

(21) Appl. No.: 11/164,790

(22) Filed: Dec. 6, 2005

(51) Int. Cl. G08B 1/08; G08B 23/00

(52) U.S. Cl. 340/539.13; 340/573.1

(57) ABSTRACT

A system whereby emergency personnel can select individuals within a specified time and geography to send emergency messages via GPS and AGPS enabled mobile communication devices that have been registered by those individuals to receive such messages.

### FIELD OF THE INVENTION

The present invention is related to a system allowing emergency personnel to locate and alert persons in a specific geographical area during emergency situations such as missing children, environmental emergencies, and crimes for the purpose of collecting evidence, identifying witnesses, preventing crime, administering first aid, and protecting persons.

### BACKGROUND OF THE INVENTION

The Problem

Time and geography are important factors for emergency personnel. Crucial evidence and eye witnesses disappear quickly in the immediate moments after a crime has been committed and the time it takes for someone to provide CPR or First Aid is often the determinate between life and death.

The Solution

Many people carry Global Positioning System (GPS) and Assisted Global Positioning System (AGPS) enabled mobile communication devices in their day-to-day lives. The location of these devices may be determined to within a few meters. This invention allows an individual to register their GPS or AGPS enabled mobile communication device to receive, recipient determined, emergency voice messages or Short Message Service (SMS) messages.

This invention would track all registered devices through a map contained in a Web Page, Web Portal, or other Graphical User Interface (GUI). Upon report of a crime, news of an environmental disaster, or other emergency notification, emergency personnel could locate their intended recipients through the GUI, and at their discretion, send an emergency message to specific devices within a defined geography and time.

### SUMMARY OF THE INVENTION

This invention allows emergency personnel to send a message to individuals most affected by an environmental disaster, or to individuals most capable of preventing a crime, obtaining evidence of a crime, or administering first aid. Upon report of a missing child, this invention could send a message to all registered devices within a specific geography and time, to be on the lookout for a vehicle, a suspect, or a child.

What is claimed is:

1. An opt-in system for registering telephone numbers, or other device identifiers, of GPS and AGPS enabled mobile communication devices to receive recipient determined messages.

2. A Webpage, Web Portal, or Graphical User Interface (GUI) containing a map with continually updated GPS and AGPS transmitter locations for the mobile communication devices described in claim 1, plotted on said map.

3. The ability to select specific mobile communication devices, as described in claim 2, to receive emergency messages.
